(19) United States
(12) Patent Application Publication
(10) Pub. No.: US 2006/0206666 A1
(43) Pub. Date: Sep. 14, 2006

(54) System and method for remotely accessible local virtual storage

(75) Inventors: Timothy M. Lambert, Austin, TX (US); Paul W. Vancil, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/078,931

(22) Filed: Mar. 11, 2005

(51) Int. Cl. G06F 13/28; G06F 12/00

(52) U.S. Cl. 711/115; 711/103

(57) ABSTRACT

A virtual local storage drive is included as a component of a managed server. The storage drive is included in a remote access card that is included in the managed server. The remote access card includes a local power source. The remote access card is coupled across a network connection to a remote client. The storage memory of the remote access card provides a depository for the exchange of data and software between the remote client and the processor of the managed server. The service processor of the remote access card performs an emulation function such that the storage drive of the remote access card appears as a local storage drive from the perspective of the processor of the managed server.

### TECHNICAL FIELD

The present disclosure relates generally to computer networks, and, more specifically, to a system and method for establishing and using remotely accessible local virtual storage in a managed server computer.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A networking system may include a server computer that is coupled through a network connection to a client computer. The server computer may also include a remote access card that is coupled to the client computer through an out-of-band connection. The remote access card may include its own microprocessor, with an embedded operating system, and a network interface card. The placement of a remote access card in the server computer permits the remote management of the server computer by the client computer. As such, despite a geographic distance between the two computers, the client computer can access and manage the operations of the server computer, including remote troubleshooting functions, remote shutdown, and remote restart functions through the out-of-band connection between the server computer and the client computer.

### SUMMARY

In accordance with the present disclosure, a system and method is disclosed in which a virtual local storage drive is included as a component of a managed server. The storage drive, which may be flash memory, is included in a remote access card that is included in the managed server. The remote access card includes a local power source. The remote access card is coupled across a network connection to a remote client. The storage memory of the remote access card provides a depository for the exchange of data and software between the remote client and the processor of the managed server. The service processor of the remote access card performs an emulation function such that the storage drive of the remote access card appears as a local storage drive from the perspective of the processor of the managed server.

The system and method disclosed herein is advantageous because the flash memory storage in the remote access cards serves as an exchange for data and software between a remote client and the processor of the managed server. Moreover, because the flash memory storage of the remote access card is emulated to the processor as local storage to the processor, the processor of the managed server is operable to boot or read data from the flash memory storage even though the flash memory storage resides on a remote access card. Thus, because the flash memory of the remote access card is accessible by both the remote client and the processor of the managed server, the remote client can save data and other software to the flash memory, which can later be read by the processor of the managed server.

The system and method of the present invention is also advantageous because the disclosed remote access card has a local power source. As such, the remote access card can be accessed and the flash memory of the remote access card can be updated despite a loss of power to the processor of the managed server. Thus, despite the loss of power to the processor and related components of the managed server, the remote client is nevertheless able to update the flash memory of the remote access card. When power is restored to the processor and related components of the managed server, the processor can boot from or otherwise access the updated content of the flash memory of the remote access card. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a managed server and a remote client;

FIG. 2 is a diagram of a managed server; and

FIG. 3 is flow diagram of a method for the transfer of data or software between a remote client and a managed server.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

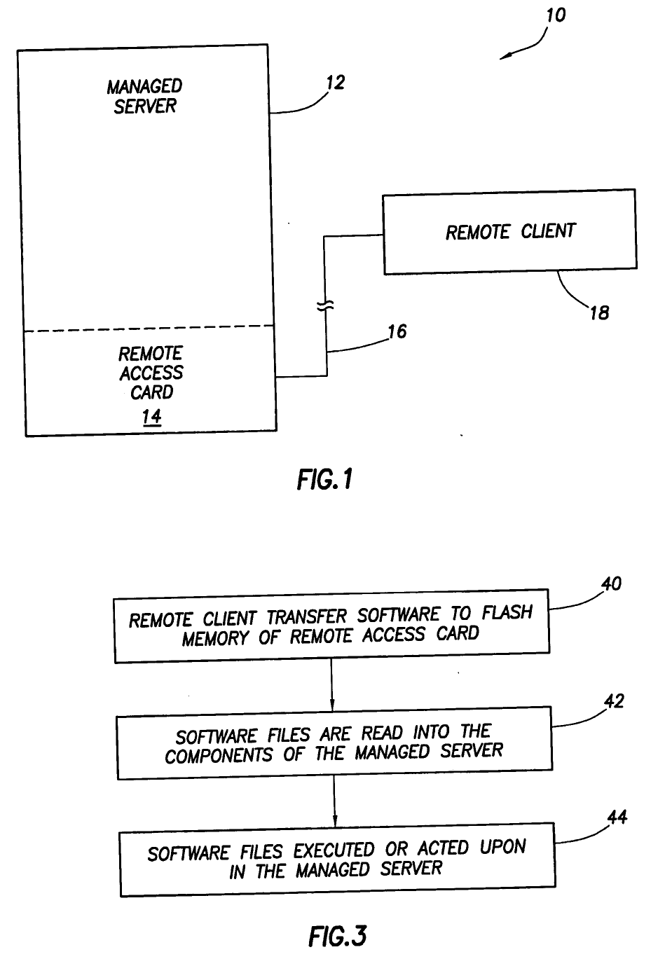

Shown in FIG. 1 is an example of the interconnection of multiple information handling systems. FIG. 1 is a diagram of a managed server 12 and a remote client 18. Managed server 12 may comprise any computer system or information handling system that provides one or more dedicated services for a network or the clients of a network. As an example, managed server 12 could comprise a file server, a web server, or a print server. Managed server 12 includes a remote access card 14. Remote access card 14 includes its own processor with embedded software or firmware. The embedded software or firmware of the remote access card comprises management software for controlling the operation of the remote access card. Remote access card 14 will also include a local power source, such as a battery, and a network interface card. The remote access card 14 of managed server 12 is coupled through the network interface card of the remote access card to remote client 18. A network connection 16, such as a LAN connection or a wireless connection, is established between the remote client 18 and managed server 12.

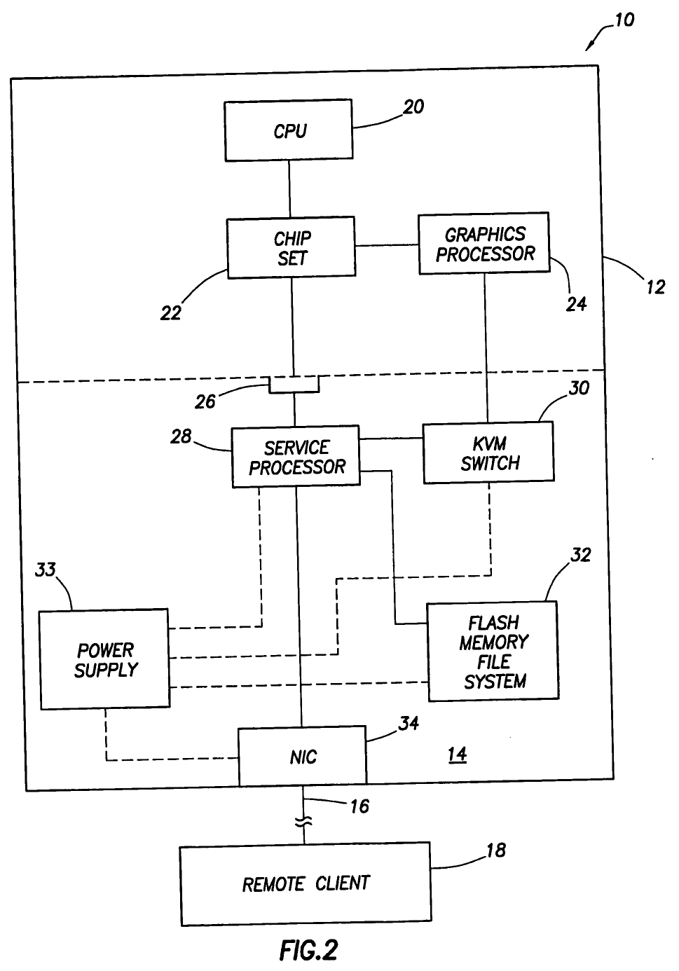

Shown in FIG. 2 is a detailed diagram of managed server 12. The architecture of managed server 12 includes a CPU 20, which is coupled to a chip set 22. Chip set 22 may comprise any set of chips of the managed server that control the flow of data to and from the processor of the managed server. Chip set 22 is coupled to a graphics processor 24. The output of graphics processor 24 is one or more signals for displaying graphical information on a computer screen or console. In the diagram of FIG. 2, the components of the remote access card 14 are shown below the dashed partition in managed server 12. Remote access card 14 is coupled to server 12 through a USB (Universal Serial Bus) port 26. Coupled to USB port 26 is a service processor 28 of the remote access card. Included within service processor 28 is a set of embedded software or firmware that governs the operation of the service processor. Service processor 28 is coupled to each of a KVM switch 30, flash memory 32, and a network interface card 34. KVM switch 30 operates to switch the output of graphics processor 24 to a console associated with the remote client 18. Network interface card is coupled to network connection 16 and serves as a connection port to remote client 18.

Flash memory 32 serves as a storage memory location for service processor 28. Service processor 28 performs an emulation function through USB port 26 such that CPU 20 of server 12 views flash memory 32 as a local hard drive of server 12. Thus, flash memory 32 is seen by CPU 20 as a local hard drive, even though flash memory 32 does not comprise disk-based memory. As a storage location, flash memory 32 may comprise a bootable storage location on which a boot image can be stored. In addition to storing a boot image, flash memory 32 can store other files and data, including application software, utilities, and files, such as a log files. In addition, the flash memory 32 can store the management software that is executed by processor 28. The USB connection 26 between server 12 and the remote access card 14 of the server provides for the rapid transfer of data between the components of the server 14 and remote access card 16. It should be recognized that an interface format other than a USB interface format could be used for the interconnection of the server and the remote access card. In many applications, a USB interface may be preferred, however, due to its performance and plug-and-play characteristics.

Flash memory 32 can also be accessed by remote client 18. Remote client 18 can access flash memory 12 through network connection 16 and network interface card 34. The placement of flash memory on remote access card 14 provides a memory location that is accessible by both the CPU 20 of server 12 and remote client 18. Because flash memory 32 is accessible by the managed server 12 and the remote client 18, flash memory 32 is a depository of software or data for exchange between managed server 12 and remote client 18. A method for the transfer of software or data between remote client 18 and managed server 12 is shown in FIG. 3. In operation, as indicated by step 40, remote client 18 can transfer to flash memory 32 software files for use by CPU 20 or other components of server 12. The software files transferred from the remote client to flash memory 32 can include, as examples, boot images, BIOS code, utilities, and firmware updates. Following the deposit of software or data at step 42, the deposited software or data is transferred at step 42 to the components of the server 12, including CPU 20, and executed or used by the affected component of the managed server at step 44.

With reference to FIG. 2, remote access card 33 includes a local power source 33, which may comprise a battery. Power connections between local battery 33 and each of the components of the remote access card are shown in dashed lines. Because the remote access card includes a local power source, remote client 18 can initiate an update of the management software of the remote access card without the necessity of server 12 being powered on. Because the remote access card is separately powered, utility or other software applications could be saved to flash memory 32 and executed without the managed server 12 being powered on. Local power source 33 may comprise a battery that is exclusively used by the remote access card. The local power source for the remote access card could also comprise a source of auxiliary power or standby power that is shared by the remote access card and the managed server.

Because the flash memory of the remote access card is emulated to perform and appear as a local hard drive from the perspective of the processor of the managed server, the flash memory of the remote access drives functions as local virtual storage for the managed server. Although the flash memory storage site is located on a locally powered remote access card, an emulation function in the remote access card causes the flash memory to appear to the processor as local storage. Because the flash memory can be manipulated remotely, the content of the flash memory location be updated to manage the operation of the server. In the case of a failure in the managed server, for example, a boot image can be saved to the flash memory of the remote access card, and the managed server could be directed to boot from the flash memory. In this manner of operation, although the memory location is under the control of the remote client, the processor of the managed server operates as though the flash memory of the remote access card is another local storage source of the managed server. Although the memory of the remote access card has been described herein as comprising flash memory, other forms of non-volatile memory may comprise the memory of the remote access card.

Although the remote access functionality of the present disclosure has been described as existing on a remote access card, the remote access functionality of the present disclosure could be integrated into the managed server and need not exist as part of a card in the managed server. Although the present disclosure has been described in detail, it should be understood that various changes, substitutions, and alterations can be made hereto without departing from the spirit and the scope of the invention as defined by the appended claims.

What is claimed is:

1. A server computer, comprising:
a processor; and
a remote access card communicatively coupled to the processor, wherein the remote access card comprises,
a service processor;
storage;
a network interface operable to communicate with a remote computer;
wherein the service processor of the remote access card performs an emulation function wherein the storage of the remote access card appears as a local storage drive from the perspective of the processor of the server computer.

2. The server computer of claim 1, wherein the remote access card is communicatively coupled to the processor through a USB port.

3. The server computer of claim 1, wherein the remote access card includes a local power supply for supplying power to the remote access card.

4. The server computer of claim 3, wherein the content of the storage of the remote access card can be updated despite the loss of power to the processor of the server.

5. The server computer of claim 1, wherein the storage of the remote access card comprises flash memory.

6. The server computer of claim 1,
wherein a boot image for the processor of the server resides on the storage of the remote access card; and
wherein the processor of the server computer can boot from the storage of the remote access card.

7. The server computer of claim 1,
wherein the remote access card is communicatively coupled to the processor through a USB port;
wherein the remote access card includes a local power supply for supplying power to the remote access card such that the content of the storage of the remote access card can be updated despite the loss of power to the processor of the server;
wherein the storage of the remote access card comprises flash memory and wherein a boot image for the processor of the server resides on the storage of the remote access card such that the processor of the server computer can boot from the storage of the remote access card.

8. A method for accessing the content of storage in a remote access card, wherein the remote access card is coupled to a remote client and is included within a managed server, comprising:
from the remote client, updating the content of the storage of the remote access card;
performing an emulation function at a service processor of the remote access card wherein the storage of the remote access card appears as a local storage drive from the perspective of the processor of the server computer; and
accessing the storage drive from the processor of the managed server, wherein the storage drive appears as a local storage drive from the perspective of the processor of the managed server.

9. The method for accessing the content of storage in a remote access card of claim 8, wherein the storage of the remote access card comprises flash memory.

10. The method for accessing the content of storage in a remote access card of claim 8, wherein the step of updating the content of the storage of the remote access card comprises the step of updating the content of the storage of the remote access card at a time when the processor of the managed server does not have power.

11. The method for accessing the content of storage in a remote access card of claim 8, wherein the updated content of the storage of the remote access card is a boot image for the processor of the managed server.

12. The method for accessing the content of storage in a remote access card of claim 11, further comprising the step of booting the processor of the managed server from the boot image of the storage of the remote access card.

13. The method for accessing the content of storage in a remote access card of claim 8, wherein the processor of the managed server accesses the storage drive of the remote access card through a USB connection.

14. The method for accessing the content of storage in a remote access card of claim 8,
wherein the storage of the remote access card comprises flash memory
wherein the step of updating the content of the storage of the remote access card comprises the step of updating the content of the storage of the remote access card at a time when the processor of the managed server does not have power; and
wherein the updated content of the storage of the remote access card is a boot image for the processor of the managed server.

15. The method for accessing the content of storage in a remote access card of claim 14, further comprising the step of booting the processor of the managed server from the boot image of the storage of the remote access card.

16. The method for accessing the content of storage in a remote access card of claim 15, wherein the processor of the managed server accesses the storage drive of the remote access card through a USB connection.

17. A remote access card for the remote management of a server computer, comprising:
a processor;
a storage device; and
a local power supply;
wherein the processor is operable to run an emulation program such that storage devices appears to be local storage from the perspective of the processor of the server computer.

18. The remote access card of claim 17, wherein the storage device comprises flash memory.

19. The remote access card of claim 17, further comprising a network interface card for coupling the remote access card to a remote computer.

20. The remote access card of claim 19, wherein the storage device may be updated despite the loss of power to the processor of the server computer.
